(19) United States
(12) Patent Application Publication
(10) Pub. No.: US 2025/0155950 A1
(43) Pub. Date: May 15, 2025

(54) POWER MONITORING AND MANAGEMENT OF ENCLOSURES AND DEVICES

(71) Applicant: Samsung Electronics Co., Ltd., Suwon-si (KR)

(72) Inventor: Marc Timothy JONES, Longmont, CO (US)

(21) Appl. No.: 18/420,750

(22) Filed: Jan. 23, 2024

Related U.S. Application Data
(60) Provisional application No. 63/548,157, filed on Nov. 10, 2023.

(51) Int. Cl. G06F 1/3234

(52) U.S. Cl. CPC G06F 1/3234

(57) ABSTRACT

Provided are systems, methods, and apparatuses for carbon footprint reporting. In one or more examples, the systems, methods, and apparatuses include a device configured to determine a power consumption of the device, determine a carbon footprint of the device based on the power consumption, and adjust a power level of the device based on the carbon footprint. In one or more examples, the systems, methods, and apparatuses include at least one of adjusting the power level of a component of the device based on measured/estimated carbon footprint of the component, determining the carbon footprint of a device based on a carbon footprint of each component of a device, and/or determining and reporting a carbon footprint for a period of time.

### CROSS-REFERENCE TO RELATED APPLICATION

This application claims the benefit of U.S. Provisional Patent Application Ser. No. 63/548,157, filed Nov. 10, 2023, which is incorporated by reference herein for all purposes.

### FIELD

The disclosure relates generally to power management, and more particularly to power monitoring and management of enclosures and devices.

### BACKGROUND

The present background section is intended to provide context only, and the disclosure of any concept in this section does not constitute an admission that said concept is prior art.

Environmental, Social, and Governance (ESG) is growing in importance for sustainability and accountability for carbon dioxide (CO2) emissions. As ESG moves from voluntary to mandatory, better mechanisms for reporting are needed. The UK, Japan, New Zealand, and Singapore has mandated reporting for public companies. Estimating the carbon footprint (e.g., carbon footprint per year) of an organization is based upon power consumption and other factors. The ability to more precisely measure power consumption permits a more precise computation of carbon footprint over estimation.

The above information disclosed in this Background section is only for enhancement of understanding of the background of the disclosure and therefore it may contain information that does not constitute prior art.

### SUMMARY

In various embodiments, described herein include systems, methods, and apparatuses for power monitoring and management of enclosures and devices. In some aspects, the techniques described herein relate to improving power consumption measurements to provide a more precise computation of carbon footprint compared to estimation.

In some aspects, the techniques described herein relate to a method of carbon footprint reporting, the method including: determining a power consumption of a device; determining a carbon footprint of the device based on the power consumption; and adjusting a power level associated with the device based on the carbon footprint.

In some aspects, the techniques described herein relate to a method, wherein determining the carbon footprint of the device includes determining a carbon footprint of a component of the device.

In some aspects, the techniques described herein relate to a method, wherein adjusting the power level associated with the device includes adjusting the power level of a component of the device.

In some aspects, the techniques described herein relate to a method, wherein determining the carbon footprint of the device is based on a component carbon footprint of each component of the device.

In some aspects, the techniques described herein relate to a method, wherein determining the carbon footprint includes determining the carbon footprint over a period of time, and further including reporting the carbon footprint for the period of time.

In some aspects, the techniques described herein relate to a method, wherein reporting the carbon footprint includes reporting an aggregated carbon footprint for the period of time that includes the carbon footprint of the device and a second carbon footprint of at least a second device for the period of time.

In some aspects, the techniques described herein relate to a method, wherein: determining the power consumption of the device is based on measuring an amount of power consumed by the device over a period of time; and determining the carbon footprint of the device is based on implementing a machine learning model that is trained on power consumption data and carbon footprint data.

In some aspects, the techniques described herein relate to a method, wherein adjusting the power level associated with the device is based on the carbon footprint of the device satisfying a carbon footprint threshold.

In some aspects, the techniques described herein relate to a method, wherein adjusting the power level includes adjusting at least one of a voltage level of a component of the device, adjusting an amperage level of the component, adjusting a frequency associated with the component, adjusting a clock speed associated with the component, adjusting an overall voltage level of the device, or adjusting an overall amperage level of the device.

In some aspects, the techniques described herein relate to a method, tracking the carbon footprint over a period of time in an event log stored on the device.

In some aspects, the techniques described herein relate to a device, including: at least one memory; and at least one processor coupled with the at least one memory configured to: determine a power consumption of the device; determine a carbon footprint of the device based on the power consumption; and adjust a power level associated with the device based on the carbon footprint.

In some aspects, the techniques described herein relate to a device, wherein determining the carbon footprint of the device includes determining a carbon footprint of a component of the device.

In some aspects, the techniques described herein relate to a device, wherein adjusting the power level associated with the device includes adjusting the power level of a component of the device.

In some aspects, the techniques described herein relate to a device, wherein determining the carbon footprint of the device is based on a component carbon footprint of each component of the device.

In some aspects, the techniques described herein relate to a device, wherein: determining the carbon footprint includes determining the carbon footprint over a period of time, and the at least one processor is configured to report the carbon footprint for the period of time.

In some aspects, the techniques described herein relate to a device, wherein reporting the carbon footprint includes reporting an aggregated carbon footprint for the period of time that includes the carbon footprint of the device and a second carbon footprint of at least a second device for the period of time.

In some aspects, the techniques described herein relate to a device, wherein the at least one processor is configured to: determine the power consumption of the device is based on measuring an amount of power consumed by the device over a period of time; and determine the carbon footprint of the device is based on implementing a machine learning model that is trained on power consumption data and carbon footprint data.

In some aspects, the techniques described herein relate to a non-transitory computer-readable medium storing code, the code including instructions executable by a processor of a device to: determine a power consumption of the device; determine a carbon footprint of the device based on the power consumption; and adjust a power level associated with the device based on the carbon footprint.

In some aspects, the techniques described herein relate to a non-transitory computer-readable medium, wherein determining the carbon footprint of the device includes determining a carbon footprint of a component of the device.

In some aspects, the techniques described herein relate to a non-transitory computer-readable medium, wherein adjusting the power level associated with the device includes adjusting the power level of a component of the device.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

Accordingly, particular embodiments of the subject matter described herein can be implemented so as to realize one or more of the following advantages: Optimize power consumption measurements of devices. Optimize computation of carbon footprint based on optimized power consumption measurements. Further, in some aspects, the disclosed systems can serve to identify carbon footprint hot spots and minimize the carbon footprint hot spots in a timely manner. Further, the disclosed mechanisms can be applied to a system, a device, and/or components of a device to increase the accuracy of carbon footprint reporting. Further, in some aspects, the disclosed systems can serve to lower the costs associated with computing carbon footprint of devices as well as collecting and reporting the computed carbon footprints. Further, the disclosed mechanisms can be applied to a system, a device, and/or components of a device to optimize and reduce CO2 emissions.

### BRIEF DESCRIPTION OF THE DRAWINGS

The above-mentioned aspects and other aspects of the present techniques will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings wherein:

FIG. 1 illustrates an example system in accordance with one or more implementations as described herein.

FIG. 2 shows details of the system of FIG. 1, according to one or more implementations as described herein.

FIG. 3 illustrates an example system for power monitoring and management of enclosures and devices in accordance with one or more implementations as described herein.

FIG. 4 illustrates an example power system for power monitoring and management of enclosures and devices in accordance with one or more implementations as described herein.

FIG. 5 illustrates an example system for power monitoring and management of enclosures and devices in accordance with one or more implementations as described herein.

FIG. 6 depicts a flow diagram illustrating an example method associated with the disclosed systems, in accordance with example implementations described herein.

FIG. 7 depicts a flow diagram illustrating an example method associated with the disclosed systems, in accordance with example implementations described herein.

FIG. 8 depicts a flow diagram illustrating an example method associated with the disclosed systems, in accordance with example implementations described herein.

FIG. 9 illustrates an example system for power monitoring and management of enclosures and devices in accordance with one or more implementations as described herein.

While the present techniques are susceptible to various modifications and alternative forms, specific embodiments thereof are shown by way of example in the drawings and will herein be described. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Any data processing may include data buffering, aligning incoming data from multiple communication lanes, forward error correction (“FEC”), and/or others. For example, data may be first received by an analog front end (AFE), which prepares the incoming for digital processing. The digital portion (e.g., DSPs) of the transceivers may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, system-on-a-chip, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

The techniques described herein include systems and methods for reporting carbon dioxide emissions from electronic devices. The systems and methods include a management controller configured to estimate and/or measure power consumption (e.g., kWh). In some cases, management controller determines a carbon footprint of the device based on power consumption. In some cases, management controller estimates a carbon footprint based on an estimation of power consumption (e.g., based on a machine learning model trained to estimate power consumption and/or carbon dioxide (CO2) emissions). In some cases, management controller adjusts one or more aspects of a given system (e.g., reduce the power and/or frequency of a component of the system) based on the estimation of the power consumption and/or CO2 emissions.

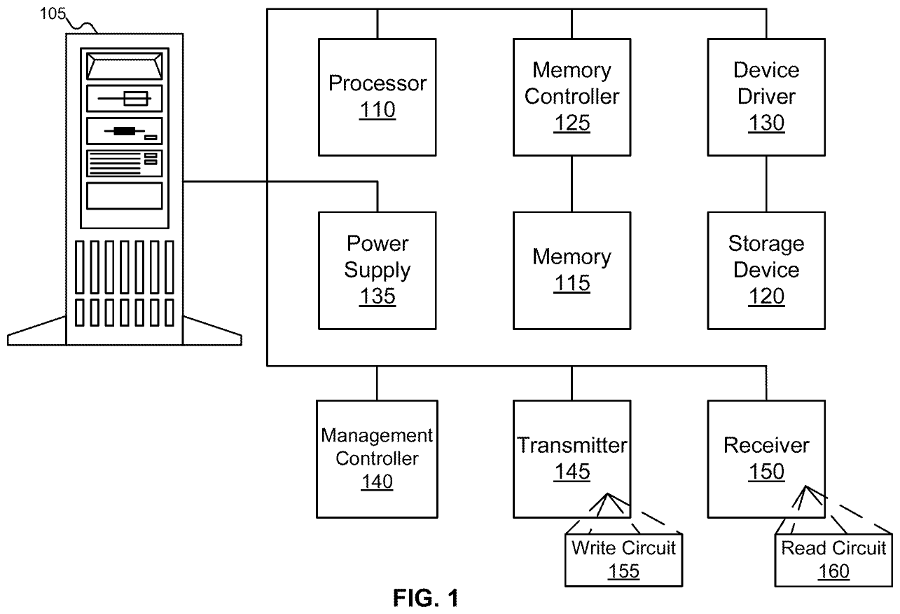

FIG. 1 illustrates an example system in accordance with one or more implementations as described herein. In FIG. 1, machine 105, which may also be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, and storage device 120. Processor 110 may be any variety of processor. It is noted that processor 110, along with the other components discussed below, are shown outside the machine for ease of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM), Phase Change Memory (PCM), or Resistive Random-Access Memory (ReRAM). Memory 115 may be a volatile or non-volatile memory, as desired. Memory 115 may use any desired form factor: for example, Single In-Line Memory Module (SIMM), Dual In-Line Memory Module (DIMM), Non-Volatile DIMM (NVDIMM), etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe) protocol, a Serial Attached Small Computer System Interface (SCSI) (SAS) protocol, or a Serial AT Attachment (SATA) protocol. Storage device 120 may also include any desired interface, including, for example, a Peripheral Component Interconnect Express (PCIe) interface, or a Compute Express Link (CXL) interface. Storage device 120 may also take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device”, embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115.

Machine 105 may also include power supply 135. Power supply 135 may provide power to machine 105 and its components. Power supply 135 may have a maximum amount of power that may be used (before exceeding the specifications of power supply 135): this information may be known to machine 105 and may be used, for example, by management controller 140 in determining a power consumption and/or a carbon footprint associated with machine 105. Operating levels of power supply 135 may be adjusted based on the techniques described herein (e.g., increase voltage, decrease voltage, increase current, decrease current, etc.). The carbon footprint of a given system (e.g., machine 105) is a function of power consumption (e.g., one or more factors, including total power consumption). However, conventional approaches do not measure or monitor power consumption to optimize and further reduce CO2 emissions. However, management controller 140 is configured to determine a power consumption and/or a carbon footprint associated with a given system (e.g., machine 105) and thus, improve the reporting of CO2 emissions.

Machine 105 may also include transmitter 145 and receiver 150. Transmitter 145 or receiver 150 may be respectively used to transmit or receive data (e.g., power consumption data, carbon footprint data). In some cases, transmitter 145 and/or receiver 150 may be used to communicate data with processor 110, memory 115 and/or storage device 120. Transmitter 145 may include write circuit 155, which may be used to write data into storage, such as a register, in memory 115 and/or storage device 120. In a similar manner, receiver 150 may include read circuit 160, which may be used to read data from storage, such as a register, in memory 115 and/or storage device 120.

The machine 105 may be implemented with any type of apparatus that may be configured as a host including, for example, a server such as a compute server, a storage server, storage node, a network server, and/or the like, a computer such as a workstation, a personal computer, a tablet, a smartphone, and/or the like, or any combination thereof. The device may be implemented with any type of apparatus that may be configured as a device including, for example, an accelerator device, a storage device, a network device, a memory expansion and/or buffer device, a graphics processing unit (GPU), a neural processing unit (NPU), a tensor processing unit (TPU), and/or the like, or any combination thereof.

Any communication between devices (e.g., host, CS device, and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced extensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, the system illustrated herein may include one or more additional apparatus having one or more additional communication interfaces.

Any of the functionality described herein, including any of the host functionality, device functionally, management controller 140 functionality, and/or the like, may be implemented with hardware, software, firmware, or any combination thereof including, for example, hardware and/or software combinational logic, sequential logic, timers, counters, registers, state machines, volatile memories such as dynamic random access memory (DRAM) and/or static random access memory (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application specific integrated circuits (ASICs) CPUs including complex instruction set computer (CISC) processors such as x86 processors and/or reduced instruction set computer (RISC) processors such as RISC-V and/or ARM processors), graphics processing units (GPUs), neural processing units (NPUs), tensor processing units (TPUs) and/or the like, executing instructions stored in any type of memory. In some embodiments, one or more components may be implemented as a system-on-chip (SOC).

In one or more examples, management controller 140 may include any combination of logic (e.g., logical circuit), hardware (e.g., processing unit, memory, storage), software, firmware, and the like. In some cases, management controller 140 may perform one or more functions in conjunction with processor 110. In some cases, at least a portion of management controller 140 may be implemented in processor 110 and/or memory 115. In some implementations, management controller 140 may determine a power consumption of machine 105 and/or one or more the depicted components of machine 105. In some cases, management controller 140 may determine a carbon footprint of machine 105 and/or one or more the depicted components of machine 105 based on the determined power consumption. In some examples, management controller 140 may store the power consumption data and/or the carbon footprint data of machine 105 in memory 115 and/or storage device 120.

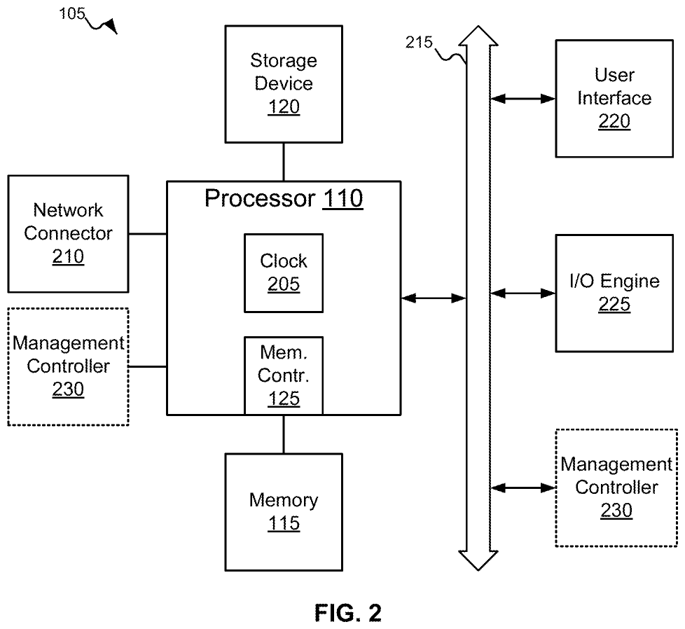

FIG. 2 shows details of machine 105 of FIG. 1, according to embodiments of the disclosure. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components. As shown, processors 110 may be coupled to management controller 230, which may be an example of management controller 140 of FIG. 1. Additionally, or alternatively, processors 110 may be connected to buses 215, to which may be attached to management controller 230.

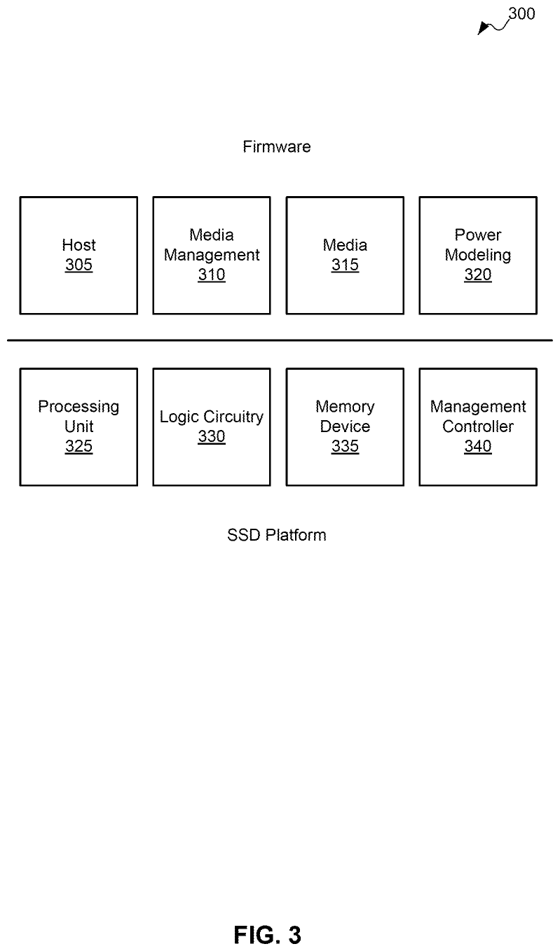

FIG. 3 illustrates an example system 300 for power monitoring and management of enclosures and devices in accordance with one or more implementations as described herein. In some cases, system 300 may be an example of machine 105. In some examples, system 300 may be storage enclosure, a rack server, a blade server, a desktop computer, a tower computer, a mini tower computer, a desktop server, a laptop computer, a notebook computer, a tablet computer, etc.

As shown, the system 300 may include a host 305, media management 310 (e.g., storage controller), media 315 (e.g., storage media, at least one storage device, at least one solid state drive), and power modeling 320. In some examples, the system 300 may include at least one processing unit 325 (e.g., a central processing unit, graphical processing unit, field programmable gate array, integrated circuit, etc.), logic circuitry 330 (e.g., NAND logic, NAND memory, NAND flash memory, etc.), memory device 335 (e.g., at least one RAM, DRAM, and/or SRAM, etc.), and a management controller 340, which may be an example of management controller 140 of FIG. 1 and/or management controller 230 of FIG. 2. In some cases, the system 300 may include a power supply unit (PSU). As shown, system 300 may include firmware to perform one or more operations, such as power monitoring operations, power management operations, carbon footprint operations, and the like.

In one or more examples, management controller 340 includes any combination of hardware, logical circuitry, firmware, and/or software to provide power measurement, power monitoring, and/or power estimation for each component of the system 300 (e.g., processing unit 325, logic circuitry 330, memory device 335, media 315, power supply, etc.) and/or for the overall system 300. In some cases, management controller 340 determines carbon dioxide emissions based on the power measurement, power monitoring, and/or power estimation.

In one or more examples, management controller 340 measures and monitors power consumption of system 300 relative to the individual components of system 300 (e.g., processing units 325, logical circuitry 330, memory device 335, media 315, power supply units, etc.) to enable estimation, measurement, and/or monitoring of CO2 emissions of system 300 and/or of a given component of system 300. In some examples, management controller 340 reports the carbon dioxide emissions via an event log of the system 300. In some cases, management controller 340 gathers carbon dioxide emission data (e.g., over a period of time), stores this data in the event log, and provides a carbon footprint report based on the carbon dioxide emission data stored in the event log.

In one or more examples, power modeling 320 includes power modeling firmware. In some cases, management controller 340 uses the power modeling firmware to measure and/or estimate power consumption based on one or more measurements of at least one component of the system 300 (e.g., processing unit 325, logic circuitry 330, memory device 335, media 315, power supply, etc.). Additionally, or alternatively, management controller 340 uses the power modeling firmware of power modeling 320 to measure and/or estimate power consumption based on a power state (e.g., active, idle, maximum power, minimum power, maximum frequency, minimum frequency) of at least one component of the system 300. Additionally, or alternatively, management controller 340 may use the power modeling firmware to measure and/or estimate power consumption based on historical measurements of at least one component of the system 300.

In one or more examples, management controller 340 identifies data associated with a device (e.g., power consumption, power consumption rate, etc.) that can be used to estimate, measure, and/or monitor instantaneous and/or accumulated carbon dioxide emissions. In some cases, management controller 340 determines carbon dioxide emissions based on embodied carbon dioxide emissions (e.g., embedded carbon dioxide emissions) and/or operational carbon dioxide emissions. Embodied CO2 emissions includes emissions generated during the production and transportation of a given device or system and/or components of the device or system (e.g., machine 105, system 300, components thereof), from the extraction of raw materials to the manufacturing process and final delivery to the end user. Operational carbon dioxide emissions include the amount of carbon dioxide emitted during the operational or in-use phase of a device or system and/or components of the device or system (e.g., machine 105, system 300, components thereof).

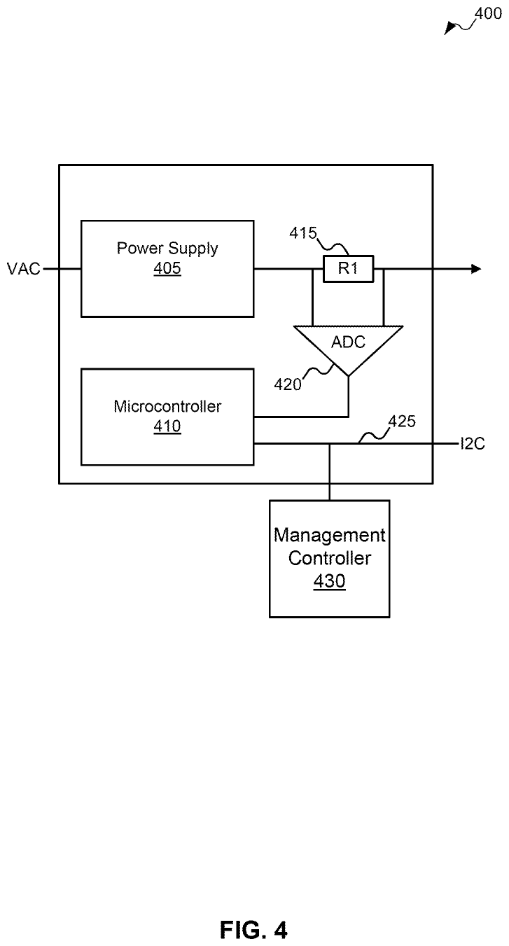

FIG. 4 illustrates an example power system 400 supply for power monitoring and management of enclosures and devices in accordance with one or more implementations as described herein. In the illustrated example, power system 400 includes a power supply 405, which may be an example of power supply 135, a microcontroller 410, a shunt 415, an analog-to-digital converter 420, and a management controller 430, which may be an example of management controller 140 of FIG. 1, management controller 230 of FIG. 2, and/or management controller 340 of FIG. 3.

In one or more examples, management controller 430 provides power measurement and/or estimation (e.g., power consumption in kWh) of a power supply unit (e.g., power supply 405). In some cases, management controller 430 may perform one or more operations described herein in conjunction with microcontroller 410. Additionally, or alternatively, at least a portion of management controller 430 may be incorporated in microcontroller 410.

In some examples, management controller 430 determines carbon dioxide emissions based at least on the power measurement and/or estimation and provides CO2 emissions reporting via an event log. In implementations, management controller 430 provides CO2 emissions reporting of an analog-to-digital converter (ADC) of a given power supply unit (e.g., ADC 420). In some cases, the carbon dioxide emissions may be determined based on ADC 420 (e.g., based overall on a given ADC) and a shunt (e.g., based on shunt 415, based on one or more current measurements via shunt 415 and ADC 420).

In the illustrated example, shunt 415 may be an electrical device that provides a low-resistance path for an electrical current of power supply 405. In some examples, power supply 405 may include one or more rails (e.g., one or more power supply rails, voltage rails), where each rail refers to a voltage provided by power supply 405. In some examples, management controller 430 may determine CO2 emissions for each rail of power supply 405 and/or determine aggregated CO2 emissions for the rails of power supply 405.

In one or more examples, power supply 405 includes a communication interface 425. In some cases, communication interface 425 is based on the inter-integrated circuit (I2C) bus interface. In some examples, management controller 430 may use communication interface 425 for measurement and/or control of power supply 405. Additionally, or alternatively, management controller 430 may use communication interface 425 for reporting information (e.g., power consumption, current measurement, CO2 emissions, carbon footprint) associated with power supply 405.

In one or more examples, the reporting information includes a power consumption measurement and/or estimation of power supply 405. Additionally, or alternatively, the reporting information may include carbon dioxide emissions (e.g., carbon footprint, embedded carbon footprint, carbon footprint based on carbon intensity of source electricity, etc.) of power supply 405 and/or ADC 420. In some cases, management controller 430 determines an efficiency rating of power supply 405 (e.g., based on manufacturer-reported efficiency rating). Accordingly, in some examples, the reporting information includes a determined efficiency rating of power supply 405. In some cases, management controller 430 compares an operating efficiency of power supply 405 to a manufacturer-reported efficiency rating of power supply 405 and adjusts an operation level of power supply 405 (e.g., voltage, current, frequency, etc.) based on the comparison.

In one or more examples, the reporting of power supply 405 may be based on system management bus (SMBus) reporting and/or power management bus (PMBus) reporting. SMBus and PMBus are communication protocols that use two wires based on I2C. Thus, as shown, management controller 430 may report power consumption and/or carbon footprint of power supply 405 via communication interface 425 (e.g., via I2C, I3C, etc.). In some cases, power consumption and/or carbon footprint reporting via communication interface 425 may be based on an enclosure that includes multiple storage devices, multiple processing units, multiple power supply units, etc.

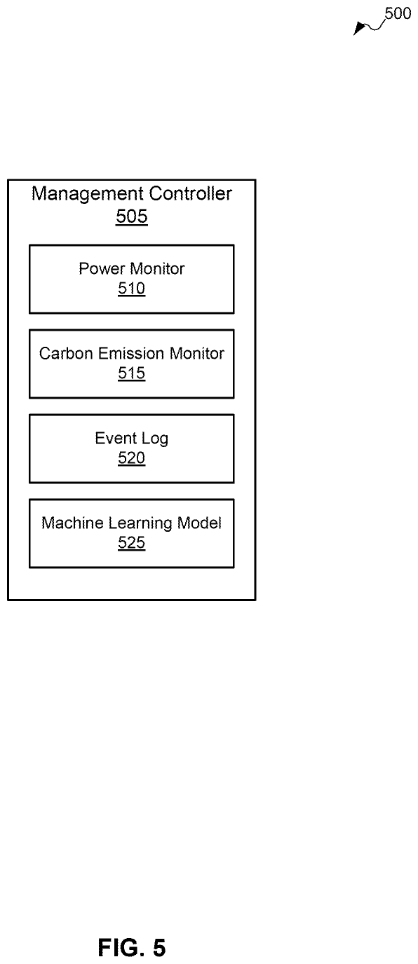

FIG. 5 illustrates an example management system 500 for power monitoring and management of enclosures and devices in accordance with one or more implementations as described herein. As shown, management system 500 includes a management controller 505, which may be an example of management controller 140 of FIG. 1, management controller 230 of FIG. 2, management controller 340 of FIG. 3, and/or management controller 430 of FIG. 4.

In the illustrated example, management controller 505 includes a power monitor 510, a carbon emission monitor 515, an event log 520, and a machine learning model 525. In some examples, management controller 505 monitors power of a given system via power monitor 510. In some cases, power monitor 510 measures and determines a power consumption of a given device, system, or components thereof (e.g., in real-time, over a period of time). In some examples, management controller 505 monitors carbon emissions of a given system via carbon emission monitor 515. In some cases, carbon emission monitor 515 determines carbon emissions (e.g., carbon footprint) of a given device, system, or components thereof (e.g., in real-time, over a period of time) based at least in part on the power consumption determined by power monitor 510.

In some examples, management controller 505 reports power consumption and/or or CO2 emissions of a given system via event log 520. In some cases, the event log 520 may include a register of a memory (e.g., memory 115 of FIG. 1 and/or FIG. 2, storage device of FIG. 1 and/or FIG. 2, memory device 335 of FIG. 3). Additionally, or alternatively, event log 520 may include a nonvolatile memory express (NVMe) persistent event log.

In one or more examples, management controller 505 enables time-based tracking of CO2 emissions. For example, management controller 505 may track time-based CO2 emissions in event log 520. In some examples, the tracking of time-based CO2 emissions enables management controller 505 to optimize and reduce CO2 emissions. In some implementations, the tracking of time-based CO2 emissions in event log 520 enables user monitoring and/or reporting of CO2 emissions. In some cases, the tracking of time-based CO2 emissions in event log 520 supports estimation, monitoring, and/or measurement of CO2 emissions of one or more devices of a given system based on one or more factors (e.g., power consumption, carbon intensity of source electricity, etc.). In some examples, management controller 505 tracks the carbon footprint over a period of time in event log 520. In implementations, the tracking of time-based CO2 emissions in event log 520 supports estimation, monitoring, and/or measurement of CO2 emissions of the system over a given period of time based on the one or more factors.

In one or more examples, machine learning model 525 that is trained on power modeling training data from at least one of one or more live systems (e.g., machine 105 of FIG. 1, system 300 of FIG. 3, power system 400 of FIG. 4), at least one test system, and/or at least one simulated system. In some cases, management controller 505 implements the machine learning model 525 to estimate power consumption and/or estimate CO2 emissions of a given system. In some cases, management controller 505 uses the estimated power consumption and/or estimate CO2 emissions to adjust one or more aspects of the system. For example, based on the estimation provided by the machine learning model 525, management controller 505 may reduce the power of one or more components of the system (e.g., reduce the power and/or frequency of at least one of a processing unit, memory device, storage device, and/or power supply unit, etc.), resulting in a lowering of measured CO2 emissions. Additionally, or alternatively, based on the estimation provided by the machine learning model 525, management controller 505 may reduce an overall power of the system, resulting in a lowering of measured CO2 emissions.

In one or more examples, a given system may include a storage enclosure with one or more storage devices (e.g., solid state drives). The storage enclosure may include other components, such as processing units, memory devices, etc. In some cases, the storage enclosure includes management controller 505. In some cases, management controller 505 connects to at least one power supply unit of the storage enclosure (e.g., power supply 135 of FIG. 1, power supply 405 of FIG. 4). Additionally, or alternatively, management controller 505 connects to at least one communication bus of the storage enclosure. Additionally, or alternatively, management controller 505 connects to at least one component of the storage enclosure (e.g., processing unit, memory device, storage device, etc.). In some examples, management controller 505 periodically queries the power supply unit of the storage enclosure for measuring, monitoring, estimating, reporting, and/or accumulating power consumption data and/or CO2 emissions of one or more components of the storage enclosure and/or of the overall storage enclosure. In some cases, management controller 505 provides the power consumption data and/or CO2 emissions to one or more third parties (e.g., for carbon footprint reporting, ESG reporting). In some cases, management controller 505 uses the power consumption data and/or CO2 emissions to optimize the operational performance of the storage enclosure. In some cases, management controller 505 uses the power consumption data and/or CO2 emissions to optimize the design of the storage enclosure (e.g., select components of the storage enclosure based on component type, component power rating, component efficiency rating, etc.).

In some cases, management controller 505 determines a carbon footprint based on embodied carbon dioxide emissions and/or operational carbon dioxide emissions of a given device or system. In some examples, management controller 505 reports parameters used to calculate the carbon footprint (e.g., carbon intensity of electricity regional/global) of a given system. The carbon intensity of electricity (CIE) refers to the grams of CO2 released per kWh of electricity. Thus, CIE is a measure of how clean a source electricity is. Electricity that is generated using fossil fuels (e.g., petroleum, coal) is generally more carbon intensive than electricity generated using other energy sources (e.g., hydroelectric, nuclear, wind, solar, geothermal). For example, electricity generated via a coal power plant generally has a higher CIE than electricity generated by a hydroelectric power plant. In some cases, the global constant is 0.475 kg carbon dioxide emissions/kWh, while the U.S. constant is 0.30 kg carbon dioxide emissions/kWh. In some examples, reporting carbon footprint is based on the energy source (e.g., based on CIE of electricity generated by coal, hydroelectric, solar, wind, nuclear, geothermal, etc.). In some examples, management controller 505 determines a carbon footprint based on the CIE associated with a device (e.g., based on the carbon intensity of the electricity supplied to the device). In some examples, management controller 505 determines a carbon footprint based on varying CIE associated with the device over a given period of time (e.g., over a reporting period, a year, a month, a week, a day, an hour, etc.).

In one or more examples, the CIE used to power a device or system may change over a given period of time. For example, electricity provided to a storage enclosure during a first period of time may have a first CIE (e.g., electricity of the first period generated by coal), and electricity provided to the storage enclosure during a second period of time may have a second CIE different from the first CIE (e.g., electricity of the second period generated by hydroelectric). Accordingly, management controller 505 may determine the carbon footprint of the storage enclosure over a reporting period that includes at least a portion of the first period and at least a portion of the second period. Thus, management controller 505 may determine the carbon footprint of the storage enclosure based on the first CIE and the second CIE. In some cases, management controller 505 may determine the carbon footprint of the device for the reporting period based on the first CIE, the duration of the first time period, the second CIE, and the duration of the second time period. In some examples, management controller 505 may identify a carbon emission hotspot in a component of a given device or system or component thereof (e.g., based on measured power consumption, CIE, etc.) and adjust an aspect of the device, system, and/or component based on the identified carbon emission hotspot.

In one or more examples, management controller 505 may maintain an accumulated carbon footprint over the lifetime of a device (e.g., where carbon footprint is based on kWh*CIE). When the CIE changes (e.g., based on a change to the source of power such as from coal to hydroelectric) then the accumulation changes accordingly. As described herein, management controller 505 may determine a power consumption of a device. In some cases, management controller 505 may determine a carbon footprint of the device based on the power consumption and adjust a power level associated with the device based on the carbon footprint. In some examples, determining the carbon footprint of the device is based on management controller 505 determining a carbon footprint of a component of the device. In some cases, adjusting the power level associated with the device is based on management controller 505 adjusting the power level of a component of the device. In some cases, determining the carbon footprint of the device is based on a component carbon footprint of each component of the device. In some cases, determining the carbon footprint is based on management controller 505 determining the carbon footprint over a period of time, and reporting the carbon footprint for the period of time. In some cases, reporting the carbon footprint is based on management controller 505 reporting an aggregated carbon footprint for the period of time that includes a first carbon footprint of a first device or first component and a second carbon footprint of at least a second device or second component for the period of time.

In one or more examples, management controller 505 may determine the power consumption of the device is based on measuring an amount of power consumed by the device over a period of time. In some cases, management controller 505 may determine the carbon footprint of the device is based on implementing machine learning model 525 trained on power consumption data and carbon footprint data. The power consumption data may include at least one of a voltage level supplied to a component of the device, an amperage level (e.g., level of current) supplied to the component, a frequency setting or clock speed setting of the component, an overall voltage level of the device, and/or an overall amperage level of the device. The carbon footprint data may include and/or be based on at least one of an embodied carbon dioxide emissions of the device, an operational carbon dioxide emissions of the device, a carbon emissions rating of the device, a carbon intensity of electricity (CIE) of the device (e.g., a real-time CIE or varying CIE of the device depending on the source of the electricity provided to the device at any given time of operation, monitoring, measurement, or reporting). In some cases, the machine learning model 525 is trained on an estimation of a relationship between carbon dioxide emissions of the device and power consumption of the device. Additionally, or alternatively, the machine learning model 525 is trained to learn the relationship between carbon dioxide emissions of the device and power consumption of the device. Accordingly, management controller 505 may determine the carbon footprint of a device or system or component thereof based on implementing the machine learning model 525.

In one or more examples, management controller 505 adjusts a power level associated with a given device based on the carbon footprint of the device satisfying a carbon footprint threshold. In some cases, management controller 505 compares the determined carbon footprint of the device to the carbon footprint threshold and determines whether the determined carbon footprint of the device exceeds the carbon footprint threshold. Additionally, or alternatively, management controller 505 may adjust a power level associated with the device based on a CIE associated with the device (e.g., based on carbon intensity of the electricity being provided to the device). In some cases, the determination of whether the device exceeds the carbon footprint threshold may be based on the CIE of the device at any given time. For example, when the device is being powered with electricity generated by coal (e.g., relatively high CIE), then the carbon footprint threshold may be exceeded relatively sooner than had the device been powered with electricity generated by hydroelectric power (e.g., relatively low CIE). When the carbon footprint of the device is determined to exceed the carbon footprint threshold, management controller 505 may adjust the power level of the device to optimize and/or minimize CO2 emissions. When the carbon footprint of the device is determined to fall below the carbon footprint threshold, management controller 505 may maintain or increase the power level of the device.

In some cases, adjusting the power level is based on management controller 505 adjusting at least one of a voltage level of a component of the device, adjusting an amperage level of the component, adjusting a frequency associated with the component, adjusting a clock speed associated with the component, adjusting an overall voltage level of the device, or adjusting an overall amperage level of the device.

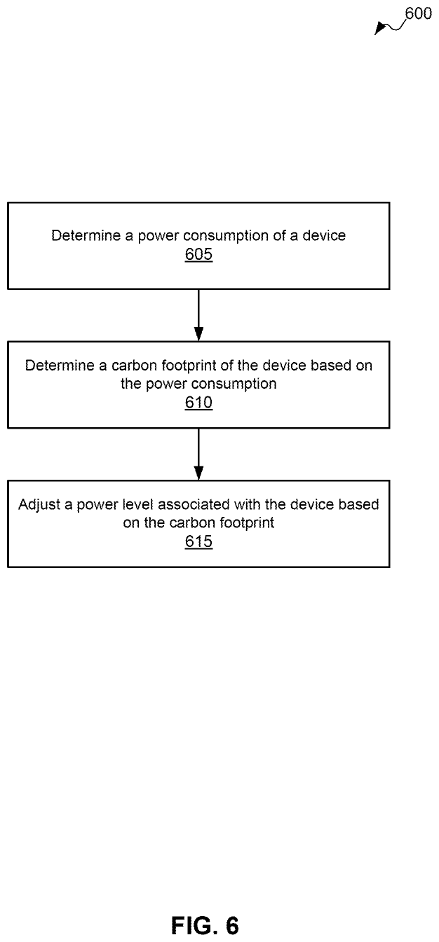

FIG. 6 depicts a flow diagram illustrating an example method 600 associated with the disclosed systems, in accordance with example implementations described herein. In some configurations, the method 600 may be implemented by management controller 140 of FIG. 1, management controller 230 of FIG. 2, management controller 340 of FIG. 3, management controller 430 of FIG. 4, and/or management controller 505 of FIG. 5. In some configurations, the method 600 may be implemented in conjunction with machine 105, components of machine 105, or any combination thereof. The method 600 is just one implementation and one or more operations of the method 600 may be rearranged, reordered, omitted, and/or otherwise modified such that other implementations are possible and contemplated.

At 605, the method 600 may include determining a power consumption of a device. For example, management controller 505 may determine a power consumption of a storage enclosure and/or components of the storage enclosure.

At 610, the method 600 may include determining a carbon footprint of the device based on the power consumption. For example, management controller 505 may determine a carbon footprint of the storage enclosure and/or components of the storage enclosure based on the determined power consumption.

At 615, the method 600 may include adjusting a power level associated with the device based on the carbon footprint. For example, management controller 505 may adjust the power level of the storage enclosure and/or components of the storage enclosure based on the determined carbon footprint.

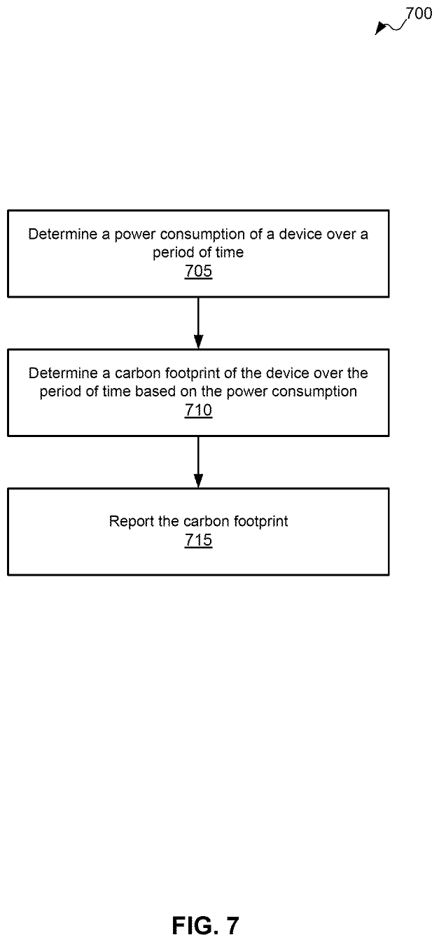

FIG. 7 depicts a flow diagram illustrating an example method 700 associated with the disclosed systems, in accordance with example implementations described herein. In some configurations, the method 700 may be implemented by management controller 140 of FIG. 1, management controller 230 of FIG. 2, management controller 340 of FIG. 3, management controller 430 of FIG. 4, and/or management controller 505 of FIG. 5. In some configurations, the method 700 may be implemented in conjunction with machine 105, components of machine 105, or any combination thereof. The method 700 is just one implementation and one or more operations of the method 700 may be rearranged, reordered, omitted, and/or otherwise modified such that other implementations are possible and contemplated.

At 705, the method 700 may include determining a power consumption of a device over a period of time. For example, management controller 505 may determine a power consumption of a storage enclosure and/or components of the storage enclosure over a period of time.

At 710, the method 700 may include determining a carbon footprint of the device over the period of time based on the power consumption. For example, management controller 505 may determine a carbon footprint of the storage enclosure and/or components of the storage enclosure over the period of time based on the determined power consumption.

At 715, the method 700 may include reporting the carbon footprint (e.g., after the period of time). For example, management controller 505 may report the carbon footprint of the storage enclosure after the period of time or at a conclusion of the period of time.

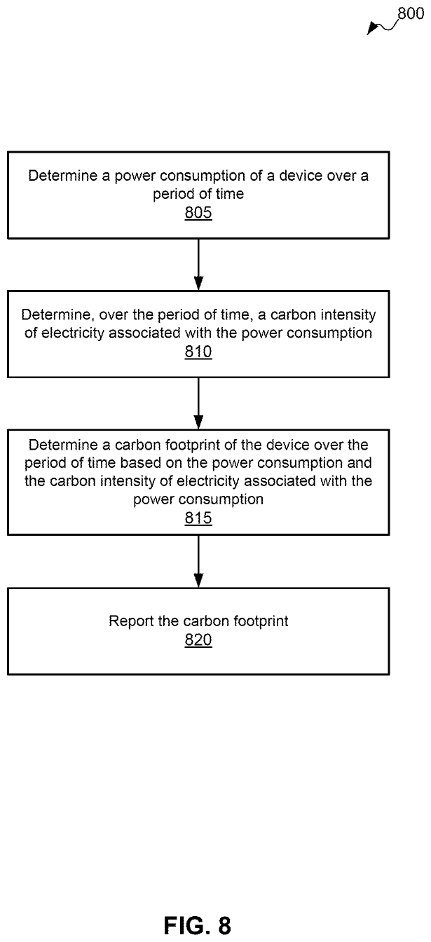

FIG. 8 depicts a flow diagram illustrating an example method 800 associated with the disclosed systems, in accordance with example implementations described herein. In some configurations, the method 800 may be implemented by management controller 140 of FIG. 1, management controller 230 of FIG. 2, management controller 340 of FIG. 3, management controller 430 of FIG. 4, and/or management controller 505 of FIG. 5. In some configurations, the method 800 may be implemented in conjunction with machine 105, components of machine 105, or any combination thereof. The method 800 is just one implementation and one or more operations of the method 800 may be rearranged, reordered, omitted, and/or otherwise modified such that other implementations are possible and contemplated.

At 805, the method 800 may include determining a power consumption of a device over a period of time. For example, management controller 505 may determine a power consumption of a storage enclosure and/or components of the storage enclosure over a period of time.

At 810, the method 800 may include determining, over the period of time, a carbon intensity of electricity associated with the power consumption. For example, management controller 505 may determine, over the period of time, the carbon intensity of electricity for power consumed by the storage enclosure and/or components of the storage enclosure.

At 815, the method 800 may include determining a carbon footprint of the device over the period of time based on the power consumption and the carbon intensity of electricity associated with the power consumption. For example, management controller 505 may determine a carbon footprint of the storage enclosure and/or components of the storage enclosure over the period of time based on the determined power consumption and the carbon intensity of electricity associated with the power consumption.

At 820, the method 800 may include reporting the carbon footprint (e.g., after the period of time). For example, management controller 505 may report the carbon footprint of the storage enclosure after the period of time or at a conclusion of the period of time.

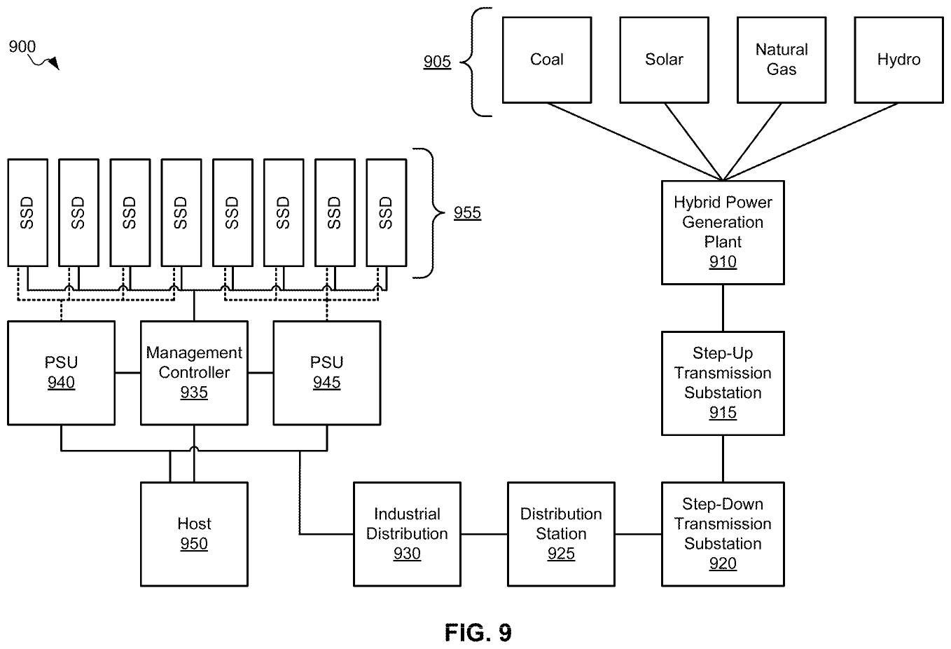

FIG. 9 illustrates an example system 900 for power monitoring and management of enclosures and devices in accordance with one or more implementations as described herein. In the illustrated example, system 900 includes power source 905, hybrid power generation plant 910, step-up transmission substation 915, step-down transmission substation 920, distribution station 925, industrial distribution 930, management controller 935, power supply unit (PSU) 940, PSU 945, host 950, and storage 955.

In some cases, management controller 935 may be an example of management controller 140 of FIG. 1, management controller 230 of FIG. 2, management controller 340 of FIG. 3, management controller 430 of FIG. 4, and/or management controller 505 of FIG. 5. In some cases, PSU 940 and/or PSU 945 may be examples of power supply 135 of FIG. 1 and/or power supply 405 of FIG. 4. In some examples, host 950 may be an example of machine 105 of FIG. 1 and/or FIG. 2. In the illustrated example, storage 955 may include an array of SSDs. In some cases, storage 955 may be an example of storage device 120 of FIG. 1 and/or FIG. 2.

As shown, power source 905 may include one or more types of power. In the illustrated example, power source 905 may include coal power, solar power, natural gas power, and/or hydroelectric power. Each type of power may be associated with a carbon intensity of electricity (CIE), which may be measured in grams of carbon dioxide emissions per kilowatt-hour of electricity generated (gCO2 e/kWh) or grams of carbon dioxide equivalent per kilowatt-hour of electricity generated (gCO2 eq/kWh). For example, coal power may be associated with a CIE of 1001 gCO2 e/kWh, solar power with a CIE of 46 gCO2 e/kWh, natural gas power with a CIE of 469 gCO2 e/kWh, and hydroelectric power with a CIE of 4 gCO2 e/kWh. The power provided by power source 905 may include at least one power type. In some cases, the power provided by power source 905 may include a blend of power types (e.g., coal power combined with solar power, etc.).

Based on the percentage contribution of power from each type of power, a CIE is calculated and then modulated into the power transmission. For example, hybrid power generation plant 910 may determine that 40% of power comes from coal (CIE 1001), 20% from solar power (CIE 46), and 40% from hydroelectric power (CIE 4). Accordingly, hybrid power generation plant 910 may determine that the average CIE based on (40%*1001+20%*46+40%*4), resulting in an average CIE of 411.2 gCO2 e/kWh for the blend of power. Accordingly, hybrid power generation plant 910 may encode the CIE of 411.2 into this blend of power by modulating the power transmission that hybrid power generation plant 910 provides to step-up transmission substation 915. In some cases, the CIE may be encoded in the power transmission based on power-line communication (e.g., power-line carrier). Power-line communication (PLC) carries data on a conductor that is also used simultaneously for electric power transmission or electric power distribution. The power transmission from hybrid power generation plant 910 to step-up transmission substation 915 may be, for example, a 20 kilovolt (kV) power transmission. Accordingly, hybrid power generation plant 910 may encode the CIE based on the power transmission being at 20 k V.

In some examples, step-up transmission substation 915 may decode the modulated 20 kV power transmission to determine the CIE (e.g., 411.2). In some cases, step-up transmission substation 915 may step up the power transmission (e.g., to 345 kV). In the illustrated example, step-up transmission substation 915 may provide the stepped-up power transmission to step-down transmission substation 920. Accordingly, step-up transmission substation 915 may encode the decoded CIE into the power transmission based on the power transmission being stepped up (e.g., to 345 kV).

In some examples, step-down transmission substation 920 may decode the stepped-up and modulated power transmission to determine the CIE (e.g., 411.2). In some cases, step-down transmission substation 920 may step down the power transmission (e.g., to 69 kV/13.8 kV). In the illustrated example, step-down transmission substation 920 may provide the stepped-down power transmission to distribution station 925. Accordingly, step-down transmission substation 920 may encode the decoded CIE into the power transmission based on the power transmission being stepped down (e.g., to 69 kV/13.8 kV).

In some examples, distribution station 925 may decode the stepped-down and modulated power transmission to determine the CIE (e.g., 411.2). In some cases, distribution station 925 may step down the power transmission (e.g., to 120V/240V). In the illustrated example, distribution station 925 may provide the stepped-down power transmission to industrial distribution 930. Accordingly, distribution station 925 may encode the decoded CIE into the power transmission based on the power transmission being stepped down to industrial power levels (e.g., to 120V/240V).

In the illustrated example, industrial distribution 930 may receive power from distribution station 925 and distribute it (e.g., over an electrical grid). As shown, industrial distribution 930 may provide power to at least one PSU (e.g., PSU 940 and/or PSU 945). In some examples, PSU 940 and/or PSU 945 may decode the modulated power to determine the CIE (e.g., 411.2). As shown, PSU 940 may provide power to management controller 935, host 950, and/or at least a portion of storage 955. Additionally, or alternatively, PSU 945 may provide power to management controller 935, host 950, and/or at least a portion of storage 955.

In some examples, PSU 940 and/or PSU 945 may provide the decoded CIE to management controller 935. Additionally, or alternatively management controller 935 may receive power from PSU 940 and/or PSU 945 and decode the modulated power to determine the CIE (e.g., 411.2). In some cases, management controller 935 may configure storage 955 based on the determined CIE. For example, management controller 935 may configure at least one SSD of storage 955 (e.g., power levels, maximum power level, minimum power level, etc.) based on the determined CIE. In some cases, management controller 935 may configure a first SSD of storage 955 with a first configuration based on the determined CIE and one or more aspects of the first SSD, and configure a second SSD of storage 955 with a second configuration (e.g., different from the first configuration) based on the determined CIE and one or more aspects of the second SSD.

Accordingly, management controller 935 may configure each SSD of storage 955 based on the decoded CIE. As the CIE changes (e.g., based on changes of power source 905), management controller 935 may determine and/or receive notification of the CIE changes and update the configuration of the SSDs of storage 955 accordingly. Thus, based on the systems and methods described herein, the calculation of the carbon footprint (e.g., of storage 955) remains accurate based on changes to power source 905.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other embodiments of the disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of carbon footprint reporting, the method comprising:
determining a power consumption of a device;
determining a carbon footprint of the device based on the power consumption; and
adjusting a power level associated with the device based on the carbon footprint.

2. The method of claim 1, wherein determining the carbon footprint of the device includes determining a carbon footprint of a component of the device.

3. The method of claim 1, wherein adjusting the power level associated with the device includes adjusting the power level of a component of the device.

4. The method of claim 3, wherein determining the carbon footprint of the device is based on a component carbon footprint of each component of the device.

5. The method of claim 1, wherein determining the carbon footprint includes determining the carbon footprint over a period of time, and further comprising reporting the carbon footprint for the period of time.

6. The method of claim 5, wherein reporting the carbon footprint includes reporting an aggregated carbon footprint for the period of time that includes the carbon footprint of the device and a second carbon footprint of at least a second device for the period of time.

7. The method of claim 1, wherein:
determining the power consumption of the device is based on measuring an amount of power consumed by the device over a period of time; and
determining the carbon footprint of the device is based on implementing a machine learning model that is trained on power consumption data and carbon footprint data.

8. The method of claim 1, wherein adjusting the power level associated with the device is based on the carbon footprint of the device satisfying a carbon footprint threshold.

9. The method of claim 1, wherein adjusting the power level includes adjusting at least one of a voltage level of a component of the device, adjusting an amperage level of the component, adjusting a frequency associated with the component, adjusting a clock speed associated with the component, adjusting an overall voltage level of the device, or adjusting an overall amperage level of the device.

10. The method of claim 1, tracking the carbon footprint over a period of time in an event log stored on the device.

11. A device, comprising:
at least one memory; and
at least one processor coupled with the at least one memory configured to:
determine a power consumption of the device;
determine a carbon footprint of the device based on the power consumption; and
adjust a power level associated with the device based on the carbon footprint.

12. The device according to claim 11, wherein determining the carbon footprint of the device includes determining a carbon footprint of a component of the device.

13. The device according to claim 11, wherein adjusting the power level associated with the device includes adjusting the power level of a component of the device.

14. The device according to claim 13, wherein determining the carbon footprint of the device is based on a component carbon footprint of each component of the device.

15. The device according to claim 11, wherein:
determining the carbon footprint includes determining the carbon footprint over a period of time, and
the at least one processor is configured to report the carbon footprint for the period of time.

16. The device according to claim 15, wherein reporting the carbon footprint includes reporting an aggregated carbon footprint for the period of time that includes the carbon footprint of the device and a second carbon footprint of at least a second device for the period of time.

17. The device according to claim 11, wherein the at least one processor is configured to:
determine the power consumption of the device is based on measuring an amount of power consumed by the device over a period of time; and
determine the carbon footprint of the device is based on implementing a machine learning model that is trained on power consumption data and carbon footprint data.

18. A non-transitory computer-readable medium storing code, the code comprising instructions executable by a processor of a device to:
determine a power consumption of the device;
determine a carbon footprint of the device based on the power consumption; and
adjust a power level associated with the device based on the carbon footprint.

19. The non-transitory computer-readable medium of claim 18, wherein determining the carbon footprint of the device includes determining a carbon footprint of a component of the device.

20. The non-transitory computer-readable medium of claim 18, wherein adjusting the power level associated with the device includes adjusting the power level of a component of the device.
